(19) United States
(12) Patent Application Publication
(10) Pub. No.: US 2022/0411687 A1
(43) Pub. Date: Dec. 29, 2022

(54) STRUCTURES AND LIQUIDS FOR LIQUID INFUSED SURFACE STRUCTURES

(71) Applicant: ExxonMobil Technology and Engineering Company, Annandale, NJ (US)

(72) Inventors: Qiuzi Li, Clinton, NJ (US); Robert J. Colby, Annandale, NJ (US); Mohsen S. Yeganeh, Newtown, PA (US); Mark A. King, Maplewood, NJ (US)

(21) Appl. No.: 17/770,074

(22) PCT Filed: Sep. 14, 2020
(86) PCT No.: PCT/US2020/050625

§ 371 Date: Apr. 19, 2022

Related U.S. Application Data
(60) Provisional application No. 62/925,277, filed on Oct. 24, 2019.

(51) Int. Cl. C09K 3/18

(52) U.S. Cl. CPC C09K 3/18

(57) ABSTRACT

A structure for use as a liquid impregnated surface (LIS) can include a surface configured to interact with a liquid to retain the liquid to the surface. The liquid can be a low viscosity hydrocarbon. In certain embodiments, the low viscosity hydrocarbon can be polyalphaolefin (PAO) or heptane, for example. Any other suitable low viscosity hydrocarbon is contemplated herein. In certain embodiments, the structure can further include the low viscosity hydrocarbon disposed on the surface.

### FIELD OF THE INVENTION

This disclosure relates to liquid impregnated surface (LIS) structures and liquids therefor.

### BACKGROUND OF THE INVENTION

Formation of ice on surfaces can lead to severe economic disadvantage in the energy field, including oil and gas exploration and production, as well as petroleum refining and petrochemistry. For instance, ice formation is a challenge when upstream operations are carried out under harsh environments, such as in the North Sea and Sakhalin. In addition, water moisture and/or CO2 can be removed from a gas stream in contact with heat exchangers if the stream is sufficiently chilled that the water and/or CO2 freeze out. This simple approach, however, is seldom practiced as the frozen material tends to adhere to the heat exchanger surface and plug the heat exchanger tubes. The current means of preventing heat exchanger plugging are costly, especially for large-scale operations. A cost-effective approach can be beneficial for natural gas (NG) to liquid natural gas (LNG) generation, CO2 capture from flue gas or natural gas, and cryogenic dehydration of gas streams, for example. The effect of ice formation on transportation and safety is also an important issue that must be resolved. Therefore, development of a surface with anti-icing properties can significantly improve operations.

Recently, it has been discovered that ice formation temperature can be reduced using a material based on lubricant impregnated surfaces (LIS). However, the ice-phobic surfaces that have been discovered can only prevent ice formation as low as −30° C., which is insufficient for many applications, such as removal of water from natural gas for LNG generation, and freeze-out of CO2 from many gas streams where the CO2 is diluted, etc.

Such conventional methods and systems have generally been considered satisfactory for their intended purpose. However, there is still a need in the art for structures and liquids for liquid impregnated surfaces. The present disclosure provides a solution for this need.

### SUMMARY OF THE INVENTION

A structure for use as a liquid impregnated surface (LIS) can include a surface configured to interact with a liquid to retain the liquid to the surface. The liquid can be a low viscosity hydrocarbon. In certain embodiments, the low viscosity hydrocarbon can be polyalphaolefin (PAO) or heptane, for example. Any other suitable low viscosity hydrocarbon is contemplated herein. In certain embodiments, the structure can further include the low viscosity hydrocarbon disposed on the surface.

In certain embodiments, the low viscosity hydrocarbon can have a viscosity of less than about 500 mPa sec at 25 degrees C. (e.g., room temperature). For example, the low viscosity hydrocarbon can have a viscosity of less than about 250 mPa sec (e.g., less than 50 mPa sec) at 25 degrees C.

The low viscosity hydrocarbon can have an ice formation temperature of below about 215 K (−58.15 degrees C.). For example, in certain embodiments, the low viscosity hydrocarbon can have an ice formation temperature of between about 215 K (−58.15 degrees C.) and about 180 K (−93.15 degrees C.).

In certain embodiments, a liquid index number

$$LI = exp ( f ( θ ) ) / η ,$$

$$where$$

$$f ( θ ) = \frac{1}{4} ( 2 + cos θ ) {( 1 - cos ( θ ) )}^{2} ,$$

wherein θ is the water contact angle on the hydrocarbon surface, and η is the viscosity of hydrocarbon at 25 degrees C. In certain embodiments, the low viscosity hydrocarbon can have a liquid index number (LI) greater than 8 (Pa.sec)-1 (e.g., greater than 40 (Pa.sec)-1 in some embodiments).

In accordance with at least one aspect of this disclosure, a structure for use as a liquid impregnated surface (LIS) can include a surface configured to interact with a liquid to retain the liquid to the surface, wherein the liquid is a low viscosity liquid at 25 degrees C. wherein the structure with a low viscosity liquid impregnated surface has an ice formation temperature of below about −85 degrees C. The structure can include the low viscosity liquid.

In accordance with at least one aspect of this disclosure, a liquefied natural gas (LNG) system can include a structure for use as a liquid impregnated surface (LIS), as disclosed herein (e.g., as described above). In certain embodiments, the structure can be a flow path within the LNG system configured to carry LNG without allowing ice formation on the structure.

In accordance with at least one aspect of this disclosure, a method can include indexing one or more liquids using a liquid index number (LI) that relates hydrophobicity to viscosity for determining a magnitude of water/ice repellant effect. In certain embodiments, the method can include labeling a container of the one or more liquids with the LI. The LI can be defined a

$$LI = exp ( f ( θ ) ) / η ,$$

$$where$$

$$f ( θ ) = \frac{1}{4} ( 2 + cos θ ) {( 1 - cos ( θ ) )}^{2} ,$$

wherein 9 is the water contact angle on the hydrocarbon surface, and η is the viscosity of hydrocarbon at 25 degrees C. The method can include any other suitable method(s) and/or portions thereof.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of an embodiment of a structure in accordance with this disclosure;

FIG. 2 is a perspective view of an embodiment of an experimental set up in accordance with this disclosure;

FIG. 3 is a chart showing ice formation temperature vs. viscosity of a polyalphaolefin (PAO) and Krytox™ at 25 degrees C.;

FIG. 4 is a chart showing ice formation temperature vs. viscosity of various grades of Krytox™ lubricant at 25 degrees C.; and

FIG. 5 is a chart showing ice formation temperature vs. viscosity of combinations of Krytox™ lubricants at 25 degrees C.

### DETAILED DESCRIPTION OF THE INVENTION

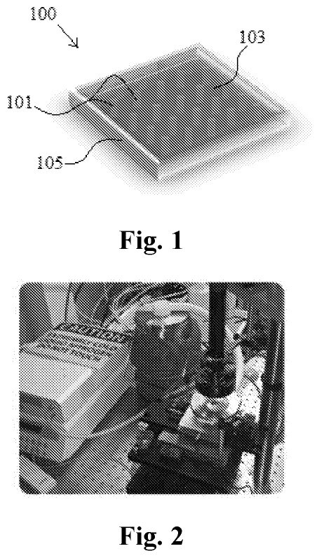

Reference will now be made to the drawings wherein like reference numerals identify similar structural features or aspects of the subject disclosure. For purposes of explanation and illustration, and not limitation, an illustrative view of an embodiment of a structure in accordance with the disclosure is shown in FIG. 1 and is designated generally by reference character 100. Other embodiments and/or aspects of this disclosure are shown in FIGS. 2-5. Embodiments can be used as anti-icing surfaces, for example (e.g., in oil and/or natural gas applications).

Referring to FIG. 1, a structure 100 for use as a liquid impregnated surface (LIS) can include a surface 101 (e.g., formed on a substrate 105) configured to interact with a liquid 103 to retain the liquid 103 to the surface. The liquid 103 can be a low viscosity hydrocarbon. The liquid can include any other suitable hydrophobic liquid, for example.

The surface 101 can include any suitable surface features (e.g., a textured surface as shown) and/or have any suitable chemical functionalization configured to retain the liquid 103 (e.g., low viscosity hydrocarbon to the surface 101). For example, the liquid 103 can be kept in place by capillary force created by the textured surface 101. The substrates and the textures can be carefully chosen to ensure that the impregnated liquid is stable. When the spreading coefficient is in accordance with:

S=Yₛₐ−Yₛᵢ−Yᵢₐ>0,

the impregnated lubricant surface is thermodynamically stable, wherein; yₛₐ is the interfacial tension between the solid substrate and air; yₛᵢ is the interfacial tension between a lubricant phase and the solid substrate; yᵢₐ is the interfacial tension between the lubricant phase and the air.

In certain embodiments, the low viscosity hydrocarbon can be polyalphaolefin (PAO) or heptane, for example. Any other suitable low viscosity hydrocarbon is contemplated herein. In certain embodiments, the structure 100 can further include the low viscosity hydrocarbon disposed on the surface 101 (e.g., as shown with liquid 103 in FIG. 1).

In certain embodiments, the low viscosity hydrocarbon can have a viscosity of less than about 500 mPa sec at 25 degrees C. (e.g., at room temperature). For example, the low viscosity hydrocarbon can have a viscosity of less than about 250 mPa sec at 25 degrees C. Any other suitable low viscosity as appreciated by those having ordinary skill in the art is contemplated herein. For example, the term low viscosity can be any viscosity under about 500 mPa sec (e.g., about 200 mPa sec, about 75 mPa sec or less).

The temperature at which microscopic ice (e.g., water ice) crystals are formed from a flow in contact with the structure 100 is referred to as the “ice formation temperature” as used herein (e.g., the temperature at which ice nucleates on the low viscosity hydrocarbon). The low viscosity hydrocarbon can be configured to cause the structure 100 to have an ice formation temperature of below about 215 K (−58.15 degrees C.). For example, in certain embodiments, the low viscosity hydrocarbon can be configured to cause the structure 100 to have an ice formation temperature of between about 215 K (−58.15 degrees C.) and about 180 K (−93.15 degrees C.). Any other suitable temperature ranges are contemplated herein (e.g., as appreciated by those having ordinary skill in the art in view of this disclosure and/or the unexpected results herein).

In accordance with at least one aspect of this disclosure, a structure, e.g., 100 for use as a liquid impregnated surface (LIS) can include a surface, e.g., 101 configured to interact with a liquid, e.g., 103 to retain the liquid to the surface. The liquid, e.g., 103 can be a low viscosity liquid such that the low viscosity liquid has an ice formation temperature of below about −85 degrees C. (e.g., about −98 degrees C.). The structure, e.g., 100 can include the low viscosity liquid. In certain embodiments, the liquid 103 can include a fluorocarbon ether polymer (e.g., Krytox™) that has been modified to include a lower viscosity to produce a lower ice formation temperature.

FIG. 2 shows an experimental setup for observing the ice formation temperature of a liquid (e.g., disposed on a surface 101). An optical microscope was used to observe the ice formation on the chosen liquid. The ice formation temperature as referred to in these experiments is the temperature at which ice nuclei are first observed with constant cooling using the setup shown in FIG. 2.

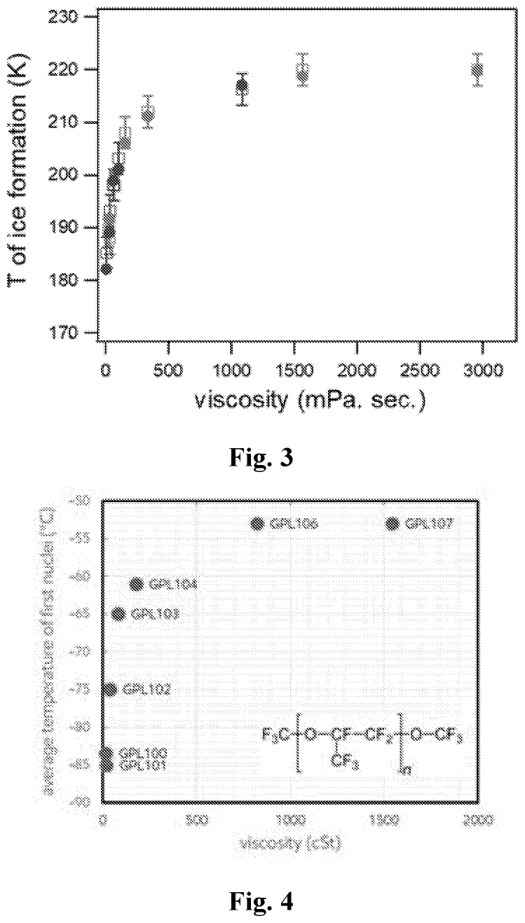

Embodiments were measured to determine the ice formation temperature thereof. The experiment was performed for PAO of varying viscosities and for Krytox™ of varying viscosities (viscosity being measured at room temperature). FIG. 3 illustrates the ice formation temperature for both Krytox™ and PAO across a similar range of viscosities. The red dots correspond to Krytox™ while the blue dots correspond to PAO. This data shows that the ice formation is independent of the chemistry of the liquid 103 and the viscosity is a critical parameter to control ice formation temperature on liquid impregnated surfaces.

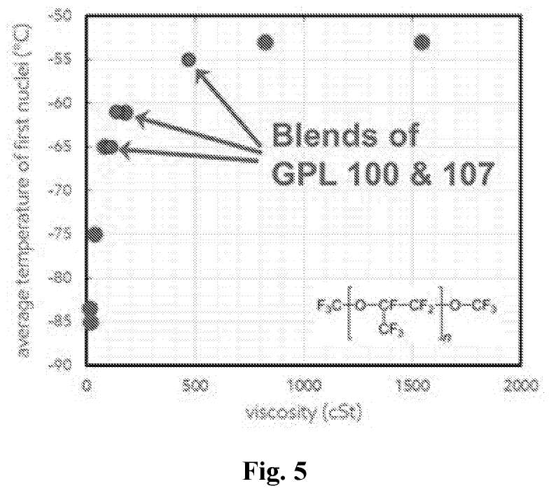

FIG. 4 shows the ice formation temperature for different grades of Krytox™. The results demonstrate that there is a significant suppression of ice formation on Krytox™ as a function of Krytox™ viscosity. The ice formation temperature is suppressed by 35° C. for the lowest viscosity Krytox™ tested. The results demonstrate that ice formation temperature follows the viscosity as opposed, e.g., to the lowest molecular weight of the lubricant's constituent molecules. FIG. 5 illustrates the ice formation temperature for blends of Krytox™ GPL 100 and GPL 107. The blend that has the same viscosity as the different grade of Krytox™ also has the same ice formation temperature.

As can be seen in all cases, for liquid with viscosity at about 500 mPa sec at 25 degrees C., a non-linear (e.g., exponential) reduction in ice formation temperature is realized with reducing viscosity. The results shown demonstrate that the viscosity is a critical measurable parameter that controls the ice formation temperature on LIS. Thus, the viscosity of lubricant used in LIS can be carefully selected depending on the temperature range of operations for different applications.

In accordance with at least one aspect of this disclosure, a liquefied natural gas (LNG) system can include a structure 100 as disclosed herein (e.g., as described above). In certain embodiments, the structure can be a flow path within the LNG system configured to carry LNG without allowing ice formation on the structure. The structure can have any suitable shape and be used as any suitable component of the LNG system.

In accordance with at least one aspect of this disclosure, a method can include reducing a liquid viscosity of a liquid impregnated structure to increase an anti-icing effect of the surface. Any other suitable method(s) and/or portions thereof are contemplated herein.

Embodiments can include low viscosity lubricant impregnated surfaces that can be used for developing surfaces with extreme anti-ice performance. Surfaces with extreme anti-ice performance can have significant impact on energy savings and improving operational performance in various applications, which includes, but not limited to, generation of LNG from natural gas, cryogenic industries, large scale heat exchangers, wind turbines, and also airline industry. Certain embodiments reduce ice formation temperatures by about 35° C. or more over existing systems. Certain embodiments can provide an LIS with superior anti-icing properties that can be applied in various petrochemical processes, e.g., a heat exchanger (e.g., for natural gas and/or carbon capture). Certain embodiments can prevent the formation of gas hydrates, critical for flow assurance and equipment integrity. In addition, our findings can be beneficial for addressing problems for wind turbines and aircrafts.

Certain liquids can be indexed in a manner that relates hydrophobicity to viscosity for determining a magnitude of water/ice repellant effect. The Liquid Index number (LI) can be defined as:

$$L I = exp ( f ( θ ) ) / η ,$$

$$where$$

$$f ( θ ) = \frac{1}{4} ( 2 + cos θ ) {( 1 - cos ( θ ) )}^{2} ,$$

where theta is the water contact angle on the hydrocarbon surface, and η is the viscosity of hydrocarbon at 25 degrees C. In certain embodiments, the low viscosity hydrocarbon can have a viscosity of less than about 250 mPa sec at 25 degrees C. In some embodiments, the low viscosity hydrocarbon can have a viscosity of much less than 50 mPa sec at 25 degrees C. The surface tension of the low viscosity hydrocarbon can be less than 30 mN/m, for example. In certain embodiments (e.g., any and/or all embodiments), LI is greater than 8 (Pa.sec)-1. In certain embodiments, LI can be larger than 40 (Pa.sec)-1.

In accordance with at least one aspect of this disclosure, a method can include indexing one or more liquids using a liquid index number (LI) that relates hydrophobicity to viscosity for determining a magnitude of water/ice repellant effect. In certain embodiments, the method can include labeling a container of the one or more liquids with the LI (e.g., applying an external label, forming/etching the container to include an LI label). In certain embodiments, the LI can be labeled on a structure (e.g., as described above) to correlate to a particular liquid for use. The LI can be as described above, for example. The method can include any other suitable method(s) and/or portions thereof.

Anti-icing surfaces can have a significant impact on energy savings in many operations of oil/gas industries. Recent efforts for developing ice-repellent material is based on liquid-impregnated surfaces (LIS), where a lubricant overlayer is maintained by holding a water-immiscible liquid into a micro-textured or nano-textured surface. The surface is chemically functionalized so that the liquid is spread over the solid surface within the texture, with capillary forces holding the liquid on the surface. An LIS-coated A1 surface able to suppress ice/frost accretion to −10° C. has been demonstrated, for example. However, anti-icing surfaces that can sustain much lower temperature may be required to be useful for certain applications, such as generation of LNG from natural gas and removal of CO2 from a gas stream.

Embodiments provide a new approach for reducing ice formation temperature and creating surfaces with extreme anti-ice performance. Embodiments include using a low viscosity impregnating lubricant on textured surfaces in order to further reduce ice formation temperature, for example.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

### PCT/EP Clauses:

1. A structure for use as a liquid impregnated surface (LIS), comprising: a surface configured to interact with a liquid to retain the liquid to the surface, wherein the liquid is a low viscosity hydrocarbon.

2. The structure of clause 1, wherein the low viscosity hydrocarbon is polyalphaolefin (PAO) or heptane, wherein the low viscosity of the liquid is the viscosity measured at 25 degrees C.

3. The structure of any of the preceding clauses, wherein the low viscosity hydrocarbon has a viscosity of less than about 500 mPa sec at 25 degrees C.

4. The structure of any of the preceding clauses, wherein the low viscosity hydrocarbon has a viscosity of less than about 250 mPa sec at 25 degrees C.

5. The structure of any of the preceding clauses, wherein the structure has an ice formation temperature of below about 215 K (−58.15 degrees C.).

6. The structure of any of the preceding clauses, wherein the structure has an ice formation temperature of between about 215 K (−58.15 degrees C.) and about 180 K (−93.15 degrees C.).

7. The structure of any of the preceding clauses, further comprising the low viscosity hydrocarbon disposed on the surface.

8. The structure of clause 7, wherein liquid index number

$$LI = exp ( f ( θ ) ) / η ,$$

$$where$$

$$f ( θ ) = \frac{1}{4} ( 2 + cos θ ) {( 1 - cos ( θ ) )}^{2} ,$$

wherein 9 is the water contact angle on the hydrocarbon surface, and η is the viscosity of hydrocarbon at 25 degrees C., and wherein the low viscosity hydrocarbon has a liquid index number (LI) greater than 8 (Pa.sec)-1, or greater than 40 (Pa.sec)-1.

9. A liquefied natural gas (LNG) system, comprising: a structure for use as a liquid impregnated surface (LIS), the structure comprising: a surface configured to interact with a liquid to retain the liquid to the surface, wherein the liquid is a low viscosity hydrocarbon.

10. The system of clause 8, wherein the structure is a flow path within the LNG system configured to carry LNG without allowing ice formation on the structure.

11. The system of any of clauses 9-10, wherein the low viscosity hydrocarbon is polyalphaolefin (PAO) or heptane.

12. The system of any of clauses 9-11, wherein the low viscosity hydrocarbon has a viscosity of less than about 500 mPa sec at 25 degrees C.

13. The system of any of clauses 9-12, wherein the low viscosity hydrocarbon has a viscosity of less than about 250 mPa sec at 25 degrees C.

14. The system of any of clauses 9-13, wherein the low viscosity hydrocarbon has an ice formation temperature of below about 215 K (−58.15 degrees C.).

15. The system of any of clauses 9-14, wherein the low viscosity hydrocarbon has an ice formation temperature of between about 215 K (−58.15 degrees C.) and about 180 K (−93.15 degrees C.).

16. The system of any of clauses 9-15, further comprising the low viscosity hydrocarbon disposed on the surface.

17. A structure for use as a liquid impregnated surface (LIS), comprising: a surface configured to interact with a liquid to retain the liquid to the surface, wherein the liquid is a low viscosity liquid wherein the low viscosity liquid has an ice formation temperature of below about −85 degrees C.

18. A method, comprising: indexing one or more liquids using a liquid index number (LI) that relates hydrophobicity to viscosity for determining a magnitude of water/ice repellant effect.

19. The method of clause 18, wherein indexing further comprises labeling a container of the one or more liquids with the LI.

20. The method of clause 18 or 19, wherein the LI is defined as:

$$LI = exp ( f ( θ ) ) / η ,$$

$$where$$

$$f ( θ ) = \frac{1}{4} ( 2 + cos θ ) {( 1 - cos ( θ ) )}^{2} ,$$

wherein theta is the water contact angle on the hydrocarbon surface, and η is the viscosity of hydrocarbon at 25 degrees C.

1. A structure for use as a liquid impregnated surface (LIS) comprising:
a low viscosity hydrocarbon disposed on a surface configured to interact with the low viscosity hydrocarbon to retain it on the surface, wherein the low viscosity hydrocarbon has a viscosity of less than about 500 mPa sec at 25 degrees C.

2. The structure of claim 1, wherein the low viscosity hydrocarbon is polyalphaolefin (PAO) or heptane.

3. (canceled)

4. The structure of claim 1, wherein the low viscosity hydrocarbon has a viscosity of less than about 250 mPa sec at 25 degrees C.

5. The structure of claim 1, wherein the structure has an ice formation temperature of below about 215 K (−58.15 degrees C.).

6. The structure of claim 1, wherein the structure has an ice formation temperature of between about 215 K (−58.15 degrees C.) and about 180 K (−93.15 degrees C.).

7. (canceled)

8. The structure of claim 1, wherein a liquid index number
$$( LI ) = exp ( f ( θ ) ) / η ,$$
$$where$$
$$f ( θ ) = \frac{1}{4} ( 2 + cos θ ) {( 1 - cos ( θ ) )}^{2} ,$$
θ is the water contact angle on the hydrocarbon surface, and η is the viscosity of hydrocarbon at 25 degrees C., and wherein the low viscosity hydrocarbon has a LI greater than 8 (Pa.sec) 1.

9. A liquefied natural gas (LNG) system comprising:
a structure for use as a liquid impregnated surface (LIS), the structure comprising:
a low viscosity hydrocarbon disposed on a surface configured to interact with the low viscosity hydrocarbon to retain it on the surface, wherein the low viscosity hydrocarbon has a viscosity of less than about 500 mPa sec at 25 degrees C.

10. The system of claim 9, wherein the structure is a flow path within the LNG system configured to carry LNG without allowing ice formation on the structure.

11. The system of claim 9, wherein the low viscosity hydrocarbon is polyalphaolefin (PAO) or heptane.

12. (canceled)

13. The system of claim 9, wherein the low viscosity hydrocarbon has a viscosity of less than about 250 mPa sec at 25 degrees C.

14. The system of claim 9, wherein the low viscosity hydrocarbon has an ice formation temperature of below about 215 K (−58.15 degrees C.).

15. The system of claim 9, wherein the low viscosity hydrocarbon has an ice formation temperature of between about 215 K (−58.15 degrees C.) and about 180 K (−93.15 degrees C.).

16. (canceled)

17. A structure for use as a liquid impregnated surface (LIS), comprising:
a surface configured to interact with a liquid to retain the liquid to the surface, wherein the liquid is a low viscosity liquid wherein the low viscosity liquid has an ice formation temperature of below about −85 degrees C.

18.-20. (canceled)
